(19) United States
(12) Patent Application Publication
(10) Pub. No.: US 2009/0190445 A1
(43) Pub. Date: Jul. 30, 2009

(54) WALL CLOCK ASSEMBLY METHOD AND APPARATUS

(76) Inventor: Michael J. Wilson, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/019,962

(22) Filed: Jan. 25, 2008

(51) Int. Cl. G04B 19/00

(52) U.S. Cl. 368/223

(57) ABSTRACT

Apparatus and methods are disclosed for assembling a wall clock having physically separate time indicators onto a wall surface in an accurate and repeatable manner. A plurality of time indicators are temporarily attached to a transfer sheet, each time indicator having a back surface with an adhesive. The time indicators are pre-arranged in a clock pattern on the transfer sheet, such that when the transfer sheet with indicators is placed against a wall surface, the time indicators adhere to the wall surface by way of the adhesive, enabling the transfer sheet to be removed with the time indicators remaining in the clock pattern on the wall surface. The system further includes a clock mechanism having one or more hands configured for placement on the wall surface in operative relation with the time indicators.

### FIELD OF THE INVENTION

This invention relates generally to wall clocks and, in particular, to a method and apparatus for assembling a wall clock having separate time indicators in a simple and reproducible manner.

### BACKGROUND OF THE INVENTION

One attractive type of wall clock includes a central portion with a minute and hour hand along with separate time indicators on the same surface. Such a clock is shown in U.S. Pat. No. 7,196,974. Other versions may be found on the walls of banks and other buildings and structures.

Unfortunately, there is no method or apparatus that allows such clock structures to be assembled in a repeatable or foolproof manner. As such, the person assembling such a clock must do so by trial and en-or, which may result in an assembly that is not pleasing aesthetically. The need remains, therefore, for a system and method for assembling such wall clocks.

### SUMMARY OF THE INVENTION

This invention resides in apparatus and method for assembling a wall clock having physically separate time indicators onto a wall surface in an accurate and repeatable manner. The apparatus includes a transfer sheet having a front surface and a back surface and a plurality of time indicators temporarily attached to the transfer sheet, each time indicator having a back surface with an adhesive. The time indicators are pre-arranged in a clock pattern on the transfer sheet, such that when the transfer sheet with indicators is placed against a wall surface, the time indicators adhere to the wall surface by way of the adhesive, enabling the transfer sheet to be removed with the time indicators remaining in the clock pattern on the wall surface. The system further includes a clock mechanism having one or more hands configured for placement on the wall surface in operative relation with the time indicators.

In one embodiment, the time indicators are temporarily attached to the transfer sheet with an adhesive that is less aggressive than the adhesive on their back surfaces. Alternatively, the time indicators are temporarily attached to the transfer sheet without an adhesive. The adhesives on the back surfaces of the time indicators are exposed with a release layer. In the preferred embodiment, the adhesives on the back surfaces of the time indicators are exposed with separate release layers, enabling a user to select which time indicators will transfer to the wall surface. The time indicators may tick marks, numbers, or any other shape. An optional level may be included.

The transfer sheet is preferably made of clear plastic, allowing a user to visualize the wall surface during the transfer process. The transfer sheet may further include one or more features such as pencil-receiving pinholes to assist in placing the clock mechanism on the wall surface in operative relation with the time indicators. The transfer sheet may include a plurality of concentric time indicators enabling a user to select one of the rings for a certain size of clock.

A method of assembling a wall clock according to the invention comprises the steps of providing a transfer sheet with a plurality of time indicators arranged in a clock temporarily attached thereto, placing the transfer sheet with indicators against a wall surface such that the indicators adhere to the wall surface in the clock pattern, and removing the transfer sheet from the time indicators on the wall surface. The method further includes the step of adhering a clock mechanism with one or more hands on the wall surface in operative relation with the time indicators.

### BRIEF DESCRIPTION OF THE DRAWINGS

FIG. 1 is a drawing of a preferred transfer sheet according to the invention;

FIG. 2A is a detailed drawing of a first step associated with assembling a wall clock according to the invention;

FIG. 2B shows a transfer sheet being placed onto a wall surface;

FIG. 2C shows a pencil being used to mark the position of the hand movement unit;

FIG. 2D shows the transfer sheet being removed from the wall surface, leaving the time indicators;

FIG. 2E shows the final step of the process, wherein a release layer is removed from the clock unit and placed onto the wall surface in alignment with the time markers;

FIG. 3 is a drawing which shows an alternative embodiment of the invention with numbers as opposed to tick marks, and with a square clock outline as opposed to a round clock outline;

FIG. 4 is a drawing of a further embodiment of the invention, showing multiple concentric time indicators, enabling wall clocks of different sizes to be assembled with the same kit; and

FIG. 5 is a detailed drawing showing a different way in which to attach the time indicators to the transfer sheet.

### DETAILED DESCRIPTION OF THE INVENTION

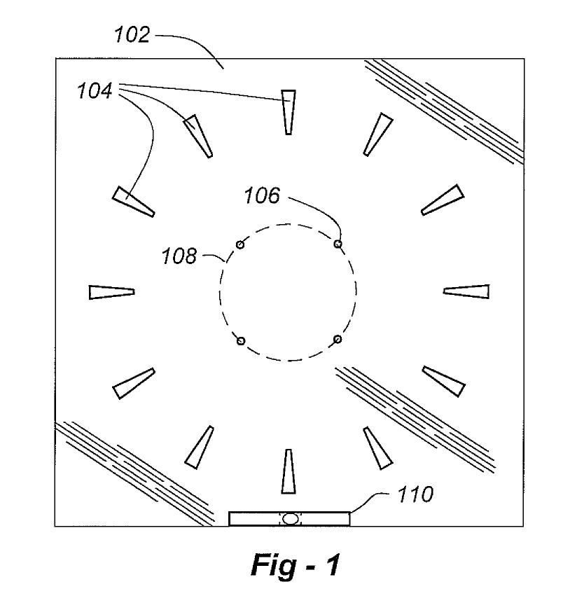

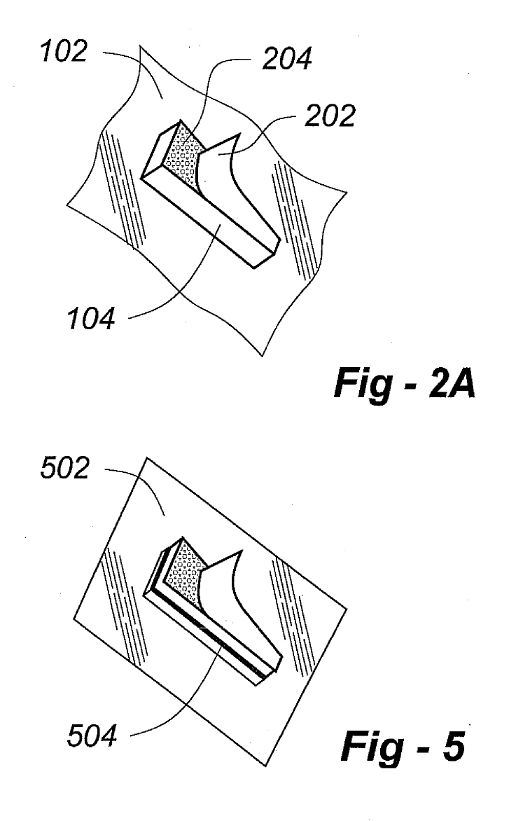

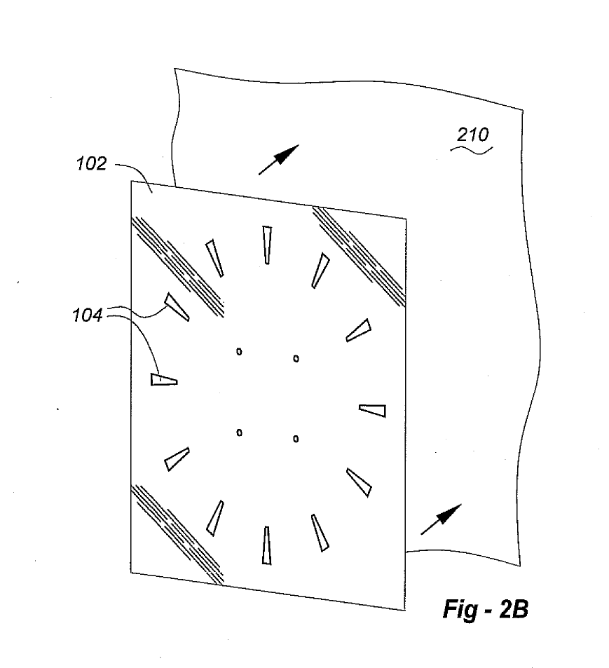

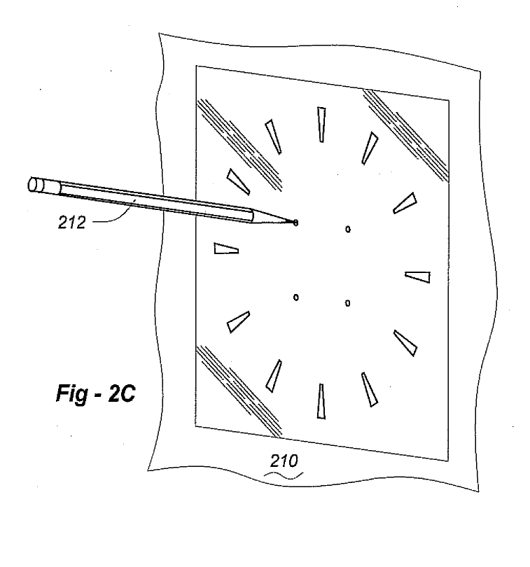

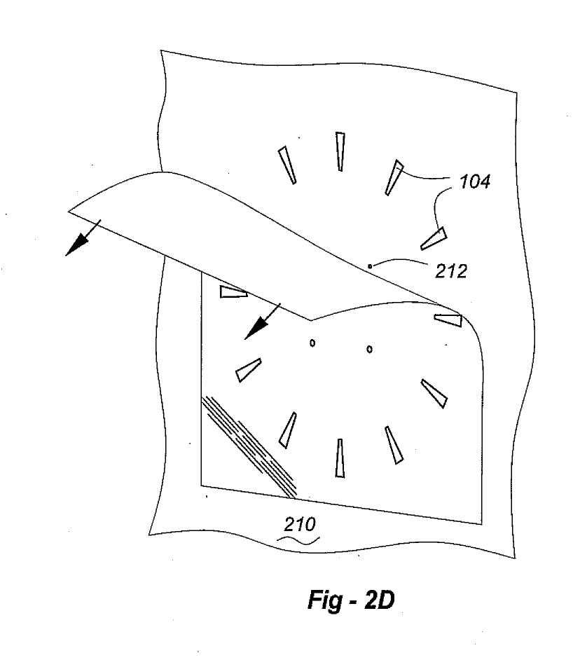

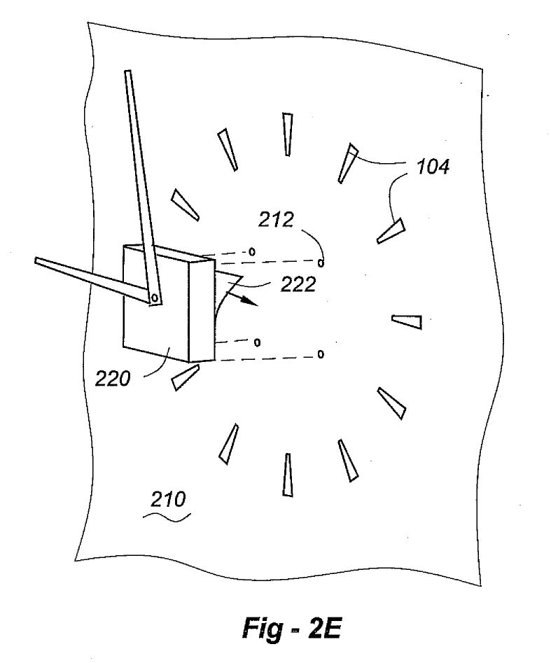

Referring now to the drawings, FIG. 1 is a drawing of a transfer sheet 102 used to place time indicators 104 onto a wall surface, better understood with reference to FIG. 2. The sheet 102 further includes one or more pinholes 106 used for an aligned placement of a clock unit onto the wall within the time indicators 104, shown in the drawing with broken line 108. The transfer sheet 102 is preferably made of a transparent plastic material, flexible enough to properly adhere the time indicators 104 onto the wall surface, but not so flimsy as to interfere with the transfer process described in further detail below. In all embodiments, an optional level 110 may be included.

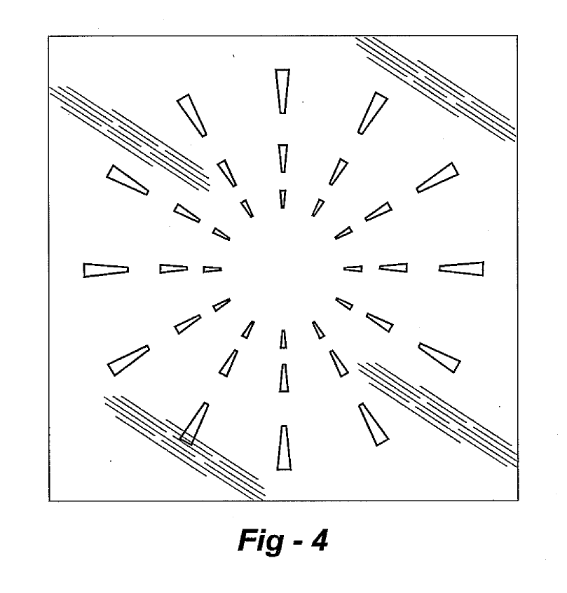

FIG. 2A is a detailed drawing showing one way in which a time indicator 104 may be adhered to the back surface of transfer sheet 102. In this case, a relatively light adhesive is used between the transfer sheet 102 and the time indicator 104, such that when the time indicator is adhered to a wall surface, the transfer sheet may be easily removed therefrom. The time indicator 104 has a back surface with a much stronger adhesive 204, which is exposed through the removal of release layer 202. While a single release layer is shown for each time indicator 104, a larger release layer over multiple time indicators may alternatively be used. However, a release layer for each time indicator is preferred, in that a user may not wish to use all of the time indicators. That is, a clock with only 12, 3, 6 and 9 o'clock positions may be preferred, in which case the other time indicators may be left covered with release layer 202 so as not to transfer to the wall surface. Additionally, as shown in FIG. 4, a transfer sheet with multiple concentric time indicators may be used, in which case only the release layers for a desired diameter would be removed for transfer.

With the release layers for the desired time indicators removed, the transfer sheet is taken to a wall surface 210 shown in FIG. 2B, and pressed against the wall surface to adhere the time indicators to the wall. As shown in FIG. 2C, while the time indicators are adhered, a pencil 212 may be used to place small dots onto the wall to show the correct align position for the clock unit subsequently placed, as shown in FIG. 2E. In FIG. 2D, the transfer sheet is removed from the selected time indicators 104, leaving them adhered to the wall surface along with pencil markings 212 which, as mentioned above, are used for correct placement of arm mechanism 220, which may be battery-operated or powered with a cord, preferably, in through the back of the wall so as not to be visible in the final assembly.

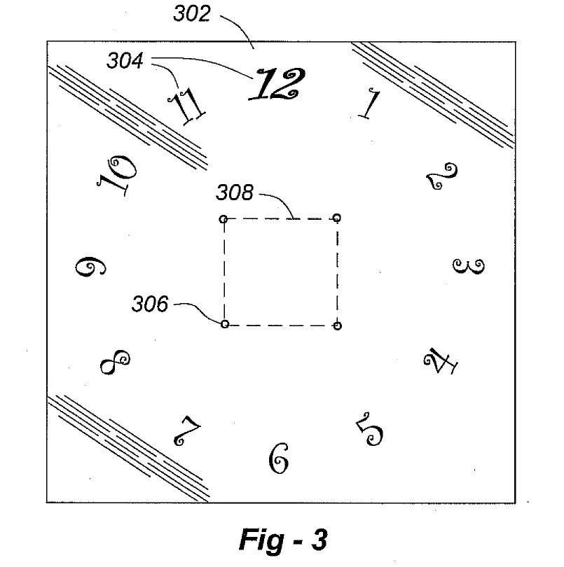

The invention is not limited in terms of the type of time indicators used. For example, as shown in FIG. 3, numerical indicator 304 may be provided on a transfer sheet 302. Any other type of indicia may also be used, including other geometric shapes such as circles or other items such as pieces of food, vegetables, teacups, medical/dental items for professional offices, and so forth. FIG. 3 also shows how holes 306 may be provided for a clock mechanism 308 having a square outline. FIG. 4 shows the way in which multiple, concentric rings of time indicators may be used, with the user then being able to select which size clock should be transferred to the wall surface.

FIG. 5 is a drawing which shows an alternative way of temporarily adhering a time indicator to a transfer sheet 502. In this case, rather than utilizing a lower-tack adhesive on the front side of the time indicator, a groove 504 is provided around the time indicator, which captures the transfer sheet 502, enabling a temporary transfer thereof to a wall surface. Any other type of temporary adhering may be used according to the invention for the purpose of transferring the time indicators.

I claim:

1. Apparatus for assembling a wall clock, comprising
a transfer sheet having a front surface and a back surface;
a plurality of time indicators temporarily attached to the transfer sheet, each time indicator having a back surface with an adhesive;
the time indicators being arranged in a clock pattern on the transfer sheet, such that when the transfer sheet with indicators is placed against a wall surface, the time indicators adhere to the wall surface by way of the adhesive, enabling the transfer sheet to be removed with the time indicators remaining in the clock pattern on the wall surface; and
a clock mechanism having one or more hands configured for placement on the wall surface in operative relation with the time indicators.

2. The apparatus of claim 1, wherein the time indicators are temporarily attached to the transfer sheet with an adhesive that is less aggressive than the adhesive on their back surfaces.

3. The apparatus of claim 1, wherein the time indicators are temporarily attached to the transfer sheet without an adhesive.

4. The apparatus of claim 1, wherein the adhesives on the back surfaces of the time indicators are exposed with a release layer.

5. The apparatus of claim 1, wherein the adhesives on the back surfaces of the time indicators are exposed with separate release layers enables a user to select which time indicators will transfer to the wall surface.

6. The apparatus of claim 1, wherein the time indicators are tick marks.

7. The apparatus of claim 1, wherein the time indicators are numbers.

8. The apparatus of claim 1, wherein the transfer sheet is made of clear plastic.

9. The apparatus of claim 1, wherein the transfer sheet further includes one or more features to assist in placing the clock mechanism on the wall surface in operative relation with the time indicators.

10. The apparatus of claim 1, wherein the transfer sheet further includes a plurality of concentric time indicators enabling a user to select one of the rings for a certain size of clock.

11. The apparatus of claim 1, wherein the transfer sheet further includes a level.

12. A method of assembling a wall clock, comprising the steps of:
providing a transfer sheet with a plurality of time indicators arranged in a clock temporarily attached thereto;
placing the transfer sheet with indicators against a wall surface such that the indicators adhere to the wall surface in the clock pattern; and
removing the transfer sheet from the time indicators on the wall surface.

13. The method of claim 12, further including the step of adhering a clock mechanism with one or more hands on the wall surface in operative relation with the time indicators.

14. The method of claim 12, further including the step of removing one or more release layers to expose an adhesive on the time indicators.

15. The method of claim 12, further including the step of removing a release layers to expose an adhesive on each time indicator to be transferred to the wall surface.

16. The method of claim 12, wherein the time indicators are temporarily attached to the transfer sheet with an adhesive that is less aggressive than the adhesive on their back surfaces.

17. The apparatus of claim 12, wherein the time indicators are temporarily attached to the transfer sheet without an adhesive.

18. The method of claim 12, wherein the time indicators are tick marks.

19. The method of claim 12, wherein the time indicators are numbers.

20. The method of claim 12, wherein the transfer sheet is made of clear plastic.

21. The method of claim 12, wherein the transfer sheet further includes one or more features to assist in placing the clock mechanism on the wall surface in operative relation with the time indicators.

22. The method of claim 12, wherein the transfer sheet further includes a plurality of concentric time indicators enabling a user to select one of the rings for a certain size of clock.

23. The method of claim 12, wherein the transfer sheet further includes a level.
